(19) United States
(12) Patent Application Publication
(10) Pub. No.: US 2026/0328361 A1
(43) Pub. Date: Oct. 22, 2026

(54) EXTERNAL REAR DEVICE FOR A MOTOR VEHICLE HAVING A LIGHTING MODULE WITH A FLEXIBLE GUIDE SHEET

(71) Applicant: VALEO VISION, Bobigny (FR)

(72) Inventors: Sid Ahmed BEDDAR, Bobigny (FR); Eduardo ALVEAR CABEZON, Bobigny (FR); Hafid EL IDRISSI, Bobigny (FR); Benoit DELANDE, Bobigny (FR)

(73) Assignee: VALEO VISION, Bobigny (FR)

(21) Appl. No.: 19/108,634

(22) PCT Filed: Sep. 6, 2023
(86) PCT No.: PCT/EP2023/074493

§ 371 Date: Mar. 4, 2025

(30) Foreign Application Priority Data
Sep. 7, 2022 (FR) 2208956

(51) Int. Cl. F21S 43/245; F21S 43/20; F21V 9/06

(52) U.S. Cl. CPC F21S 43/245; F21S 43/255; F21V 9/06

(57) ABSTRACT

The invention relates to an external rear device for a motor vehicle. The device includes an outer surface on which at least one lighting module is arranged. Each lighting module includes an assembly of at least one flexible guide sheet, each flexible guide sheet of the assembly being suitable for receiving light rays via at least one edge of the flexible guide sheet and for reflecting the light rays in a direction which is substantially normal to a surface of the flexible guide sheet according to at least one pattern etched in the flexible guide sheet. The device also includes at least one light-injection element which is suitable for receiving light and for distributing the light in the assembly of flexible guide sheets, and at least one light source which is suitable for injecting light into the light-injection element.

### TECHNICAL FIELD

The present invention relates to the field of luminous modules for an external rear device for an automotive vehicle, notably light guidance luminous modules. The invention particularly, but not exclusively, applies to displaying luminous patterns on an external device arranged at the rear of an automotive vehicle.

### BACKGROUND OF THE INVENTION

These days it is common practice to display luminous patterns inside an automotive vehicle, in order to convey information, for esthetic customization purposes or to create ambiance. In addition, it is also desirable to be able to display such light patterns outside the vehicle, in order to be seen by an observer located outside the vehicle, in order to convey information or for esthetic purposes.

Such patterns are preferably displayed with a high resolution level.

To this end, it is known practice to use screens, such as LCD screens.

However, this technology is not only expensive but also sensitive to environmental conditions, such as temperature, humidity or UV radiation. It is thus unsuitable for external uses, with the external devices of an automotive vehicle experiencing variable environmental conditions, including bad weather, and also being exposed to mechanical impacts.

Moreover, having a flexible luminous module is preferable for facilitating its integration into any type of device, notably external devices located at the rear of the automotive vehicle. This is notably the case outside an automotive vehicle, in which the external devices, such as the various elements of the bodywork, have non-planar surfaces.

Finally, the aforementioned solutions have the disadvantage of high energy consumption, which is even higher the larger the surface area of the device in which a luminous module is to be integrated.

Therefore, a requirement exists to provide an external device at the rear of an automotive vehicle comprising a luminous module that is able to display an accurate light pattern, and that is reliable, inexpensive, low energy consuming and easy to integrate.

### SUMMARY OF THE INVENTION

The present invention improves the situation.

A first aspect of the invention relates to an external rear device for an automotive vehicle, said device comprising a surface, on which at least one luminous module is arranged, with each luminous module comprising:
an assembly of at least one flexible guide sheet, with each flexible guide sheet of the assembly being able to receive light rays via at least one edge of said flexible guide sheet and to reflect the light rays in a direction substantially normal to a surface of the flexible guide sheet in at least one pattern etched into said flexible guide sheet;
at least one light injection element able to receive light and to distribute the light in the assembly of at least one flexible guide sheet;
at least one light source able to inject light into said at least one light injection element.

The use of a flexible guide sheet facilitates the integration of the luminous module in an external rear device for an automotive vehicle, and is also compact, since the thickness of the luminous module can be low. Furthermore, large surface areas can be illuminated while limiting the number of light sources used.

According to one embodiment, the flexible guide sheet and the light injection element are produced as a single piece. Thus, it is possible to dispense with the junction means between the light injection element and the guide sheet, which reduces the risk of disrupting the light rays on their path toward the guide sheet. Consequently, the loss of light rays is minimized for better luminous efficiency.

According to one embodiment, the light injection element comprises a plurality of light injection guides connected to each other so as to form this light injection element. In other words, each injection guide is connected to one or more other injection guides in order to form an integral assembly forming the light injection element.

By way of an example, the light injection guides are folded and are partially overlaid on one another so as to form a stack able to receive light rays from a light source. Specifically, the stack has an entry surface, the thickness of which corresponds to the emission surface of the light source.

According to some embodiments, the external rear device can further comprise a protective layer arranged on said at least one luminous module, with the luminous module being included between the surface and the protective layer.

Thus, at least mechanical protection is provided for the luminous module, which allows its service life to be extended. In particular, an external device for an automotive vehicle is particularly exposed to mechanical impacts. The protective layer can also protect the luminous module from bad weather such as rain or hail.

Additionally, the protective layer may be transparent and may be able to filter ultraviolet rays.

Thus, the protective layer is also able to protect the luminous module from ultraviolet rays so as not to degrade the pattern or patterns etched on the one or more flexible guide sheets of the luminous module.

Additionally or as a variant, the protective layer can be an encapsulation layer able to encapsulate the luminous module between the surface and the encapsulation layer.

Thus, the protective layer also allows the luminous module to be fixed or retained against the surface of the device. It is thereby able to fulfil several functions, both protecting and fixing, with a single element.

According to some embodiments, the surface can be a rigid panel with a given appearance, with the device having said appearance when each light source is disabled, and the pattern of said at least one flexible guide sheet can change the appearance of the surface when at least one light source is activated.

Thus, the luminous module can fulfil an esthetic or signaling function when at least one of its light sources is activated, while being indistinguishable when all its sources are deactivated.

According to some embodiments, the device can comprise a tail light for an automotive vehicle, and at least one flexible guide sheet can at least partially cover said tail light for an automotive vehicle.

At least one luminous module can thus fulfil a signaling function for vehicles located behind the vehicle.

Additionally, the device can comprise a right tail light and left tail light for an automotive vehicle, and can comprise a first luminous module arranged in a central position between the right tail light and the left tail light, a second luminous module arranged on the left tail light, and a third luminous module arranged on the right tail light.

It is thereby possible to use a large rear surface of the automotive vehicle to fulfil signaling and/or esthetic functions.

Again additionally, said at least one pattern of the second luminous module is identical to said at least one pattern of the third luminous module, and wherein said at least one pattern of the first luminous module is different from said at least one pattern of the second luminous module and of the third luminous module.

Thus, the device can show several items of signaling information simultaneously, or can show signaling information and fulfil an esthetic function. As a variant, the patterns displayed by the various luminous modules can be complementary and together produce signaling information.

According to some embodiments, the external rear device can further comprise a control element able to control said at least one light source.

It is thus possible to control the light source and thus vary the pattern displayed by the luminous module. Luminous animations or dynamic information thus can be displayed.

Additionally, at least one luminous module may be able to display at least one symbol in a given area of the luminous module based on the pattern of said at least one flexible guide sheet of the assembly.

Thus, it is possible to display at least one symbol on an external rear device for an automotive vehicle. Such a symbol can have an esthetic or information signaling function.

Again additionally, at least one luminous module may be able to display at least one first symbol in a given first area of the luminous module and at least one second symbol in a given second area of the luminous module, based on the pattern of said at least one flexible guide sheet of the assembly.

Thus, it is possible to produce several symbols with the same luminous module.

According to some embodiments, for at least one luminous module, the luminous module can comprise a first injection element and a second injection element, said at least one source may be able to selectively inject light into the first injection element and into the second injection element, and the first light injection element and the assembly of at least one flexible guide sheet can be arranged so as to project light according to a first pattern and the second light injection element and the assembly of at least one flexible guide sheet can be arranged so as to project light according to a second pattern.

Thus, the first injection element and the second injection element can be used separately, which allows animations by color variation or by spatial variation of the light rays emitted by the assembly. It is also possible to display two distinct patterns, each of which may correspond to given signaling information.

Additionally, the luminous module can comprise a first light source able to inject light into the first light injection element and a second light source able to inject light into the second light injection element.

Controlling a dynamic display is thus enabled by controlling the sources, the respective activations of which are independent of each other. It is also possible to display two distinct patterns, each of which may correspond to given signaling information.

Additionally or as a variant, the first injection element can be arranged so as to inject light into a first section of the edge of the guide sheet of the assembly, and the second injection element can be arranged so as to inject light into a second section of the edge of the flexible guide sheet, with a first portion of the flexible guide sheet located facing the first section of the edge being etched according to the first pattern, and a second portion of the flexible guide sheet located facing the second section of the edge being etched according to the second pattern.

Thus, it is possible to produce several patterns at distinct spatial positions, via a single flexible guide sheet, which limits costs and the bulk associated with the external rear device.

As a variant, the assembly can comprise at least one first and one second flexible guide sheet, with the first pattern being etched into the first flexible guide sheet and the second pattern being etched into the second flexible guide sheet, the first injection element being arranged so as to inject light into an edge of the first flexible guide sheet and the second injection element being arranged so as to inject light into an edge of the second flexible guide sheet.

It is thereby possible to produce complex variations of patterns and/or to provide a luminous module covering a large lighting area and/or to display a large number of patterns at the same location on the device.

Additionally, the first and second guide sheets can be overlaid in the luminous module, in order to project the first and second patterns into a common area of the luminous module.

This allows the pattern projected into the common area to be varied. It is thus possible to display different signaling information, notably for the attention of vehicles following the automotive vehicle with the device installed at the rear. As a variant, an animation can be produced by dynamically varying the pattern of the common area or by changing its color.

As a variant, the first and second flexible guide sheets can be placed next to each other so as to project the first and second patterns at distinct positions.

This allows large emission surface areas to be covered, notably of more than 100 cm2, while allowing integration on irregular and complex surfaces.

Additionally, the assembly comprises more than two flexible guide sheets placed next to each other so as to form a matrix of flexible guide sheets, with each flexible guide sheet being associated with a light injection element able to inject light into an edge of the flexible guide sheet and each flexible guide sheet having at least one pattern etched into said sheet.

This allows complex light animations to be created by spatial variation of the projected light rays, while allowing easy integration into devices with complex surfaces.

According to some embodiments, the control element may be able to control said at least one source to selectively project light according to the first pattern and according to the second pattern.

Thus, a single element is able to selectively control the injection of light into the various light injection elements of the luminous module, which improves the synchronization for displaying luminous patterns relative to one another. The control element can notably control the display of signaling information from among several possibilities.

According to some embodiments, the thickness of each flexible guide sheet of the assembly can range between 0.2 and 1 mm.

This thickness affords the flexible guide sheet significant flexibility, and facilitates its integration, notably on curved supports.

According to some embodiments, each flexible guide sheet can comprise a film comprising microstructures and each pattern can be etched by ultra-violet printing the microstructures of the film.

Such microstructures allow patterns to be produced with good resolution, while maintaining a high level of transparency for the flexible guide sheet.

In addition, for each flexible guide sheet, a surface density of microstructures can decrease with the distance from the edge of the guide sheet into which the light is injected.

The homogeneity of a pattern projected by the flexible guide sheet is thus improved.

According to some embodiments, each injection element can comprise a plurality of injection guides, with each injection guide being able to receive light from one end of the guide and to guide the light to a given longitudinal position of the injection element, with the longitudinal positions of the injection guides all being different so as to longitudinally distribute the light in the injection element.

Thus, it is possible to homogeneously distribute light in the edge of the flexible guide sheet, which improves the projection quality of the first and second patterns.

### BRIEF DESCRIPTION OF DRAWINGS

Further features and advantages of the invention will become apparent with reference to the following detailed description, and the appended drawings, in which:

FIG. 1 illustrates a luminous module for an external device for an automotive vehicle, according to a first embodiment of the invention;

FIG. 2A illustrates an injection element of a luminous module according to one embodiment of the invention;

FIG. 2B illustrates a luminous module according to one embodiment, with said luminous module comprising a flexible light guide sheet and a light injection element produced as a single piece;

FIG. 2C illustrates the light injection element of the luminous module shown in FIG. 2B;

FIG. 3A illustrates a luminous module for an external device for an automotive vehicle, according to a second embodiment of the invention;

FIG. 3B illustrates a variant of the luminous module of the second embodiment of the assembly;

FIG. 4 illustrates a luminous module for an external device for an automotive vehicle, according to a third embodiment of the invention;

FIG. 5 illustrates a luminous module for an external device for an automotive vehicle, according to a fourth embodiment of the invention;

FIG. 6 illustrates an external rear device for an automotive vehicle according to some embodiments of the invention;

FIG. 7 illustrates an external rear device according to a first embodiment of the invention;

FIG. 8A illustrates a view of the external rear device according to the first embodiment of the invention, when its light sources are turned off;

FIG. 8B illustrates a view of the external rear device according to the first embodiment of the invention, when its light sources are turned on;

FIG. 9A illustrates an external rear device according to a second embodiment, when first light sources are turned on; and

FIG. 9B illustrates the external rear device according to the second embodiment, when second light sources are turned on.

### DETAILED DESCRIPTION OF THE INVENTION

The description focuses on the features that set apart the external device and the luminous module from those known in the prior art.

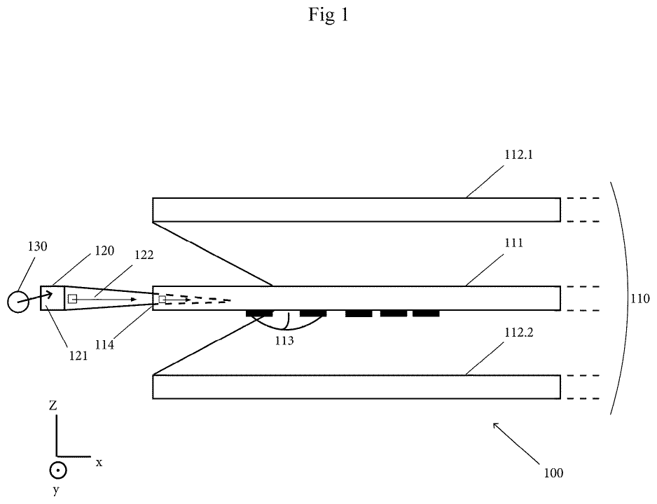

FIG. 1 shows a luminous module 100 for an external device for an automotive vehicle, according to a first embodiment of the invention.

The luminous module 100 comprises a flexible guide sheet 110 able to receive light rays via an edge 114 and to reflect the light rays in a direction Z substantially normal to a surface of the flexible guide sheet, which thus extends in an X-Y plane in FIG. 1.

A guide sheet is understood to mean an optical guide element, one of the dimensions of which is much smaller than the other two dimensions in space, for example, less than one or more orders of magnitude. As illustrated in FIG. 1, a flexible guide sheet is considered herein, the thickness of which along the Z-axis is lower by at least two orders of magnitude than its dimensions along the X-Y plane in which the flexible guide sheet 110 extends.

The flexible guide sheet 110 can include a flexible film 111 at its core comprising at least one edge 114, which is able to guide the light rays in an overall direction X, and comprising a set of microstructures 113 able to reflect the light rays guided in the flexible film 111 outside the flexible guide sheet 110, notably in one or more directions substantially along the Z-axis.

The flexible film 111 can be a substrate film made of polycarbonate (PC), polymethyl methacrylate (PMMA), thermoplastic polyurethane (TUP) or polyethylene terephthalate (PET). The thickness, i.e., a dimension along the Z-axis, of the flexible film 111 can range between 12 and 1,000 micrometers. More specifically, the thickness of the flexible film 111 can range between 50 and 1,000 micrometers, for example, between 200 and 500 micrometers. As a variant, it is the thickness of the flexible guide sheet 110 that ranges between 200 and 1,000 micrometers.

The aforementioned materials, associated with a limited thickness, as described above, allow a flexible film 111 to be obtained. Other materials can be considered for the composition of the flexible film 111. However, it is preferable, according to the invention, to provide deformable and transparent materials.

A thin coating of microstructures 113 can be applied to one of the faces of the flexible film 111, or can be integrated in the flexible film 111. The thickness of the coating of microstructures 113 along the Z-axis notably can be less than 20 micrometers.

Such microstructures 113 can assume the general shape of a bump, on which the light rays are reflected in a direction substantially along the Z-axis. Such microstructures 113 may allow the light rays exiting the flexible film 111 to form a pattern. To this end, the microstructures 113 can be etched by ultraviolet printing, according to the desired pattern.

Microstructures 113 are understood to mean structures, or irregularities in the flexible film, with dimensions that are less than a few micrometers. The microstructures thus also cover nanoscale structures. Such sizes of microstructures 113 ensure high transparency of the flexible film 111. In particular, transparency of the order of 97 % can be obtained in practice by the use of microstructures 113. As a variant, the flexible guide sheet can be semi-transparent or opaque.

Advantageously, the microstructures 113 can be distributed along the X-axis such that a linear density of microstructures 113 is proportional to the distance from the edge 114 through which the light rays injected by the injection element 120 are received. In other words, the farther the microstructures 113 are from the edge 114, the more densely they are grouped. Such a distribution advantageously ensures homogeneous distribution, along the X-axis, of the light intensity of the pattern emitted by the flexible guide sheet 110.

The flexible guide sheet 110 can further comprise one or two optional protective layers 112.1 and 112.2, which allow the flexible film 111 to be mechanically protected. Furthermore, one of the protective layers 112.1 and 112.2 can at least include an anti-UV treatment, for protecting the flexible film against UV rays, once the microstructures 113 have been etched. Without such UV protection, the pattern projected by the flexible guide sheet 110 is likely to degrade over time, especially when it is exposed to rays from the sun.

The flexible film 111 and the protective layers 112.1 and 112.2 are shown spaced apart in FIG. 1, purely for illustrative purposes. However, it will be understood that the protective layers 112.1 and 112.2 can be joined to the flexible film, notably by rolling.

With the guide sheet 110 being flexible, it is not necessarily included in a plane but can be curved, depending on the position it is placed in and the mechanical stresses applied thereto.

The luminous module 100 illustrated in FIG. 1 also comprises a light injection element 120, also called light bar, because it extends longitudinally in a direction Y, and is able to inject light in a direction normal to its longitudinal direction, for example, along the X-axis when it is arranged in the manner shown in FIG. 1.

The light injection element 120 has a rectangular or square section in FIG. 1. However, the light injection element 120 can have a round, oval, or polygonal section.

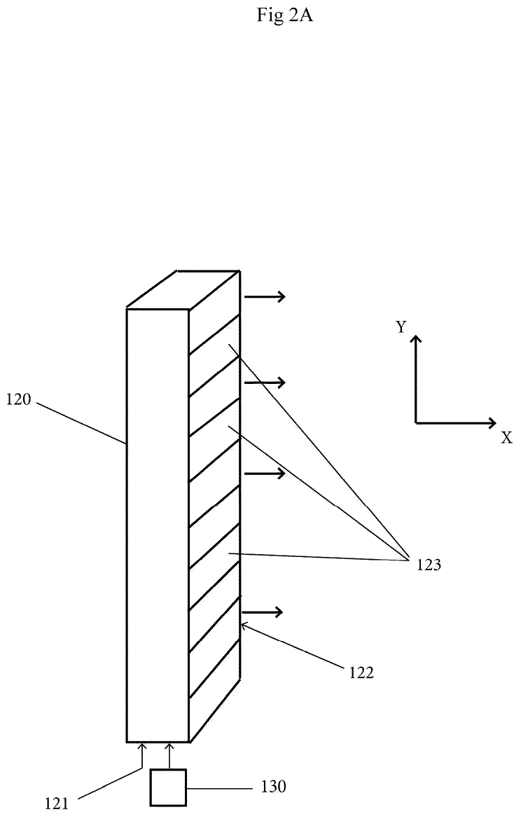

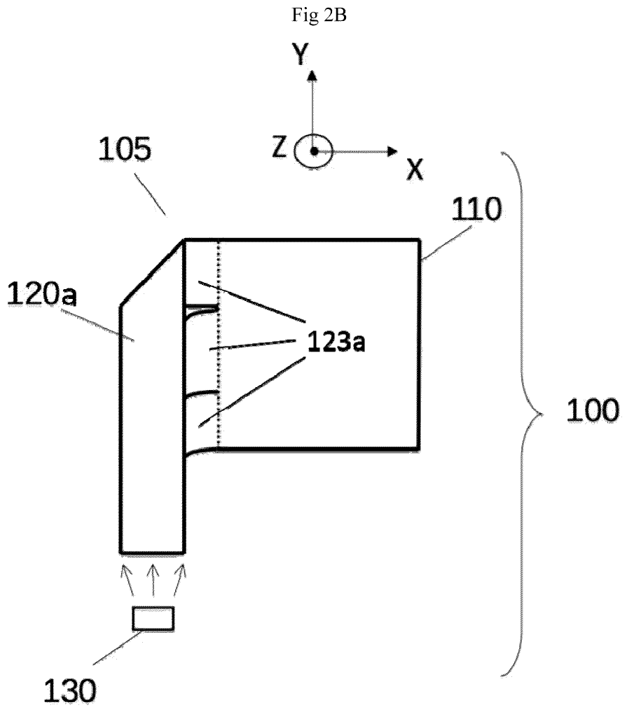

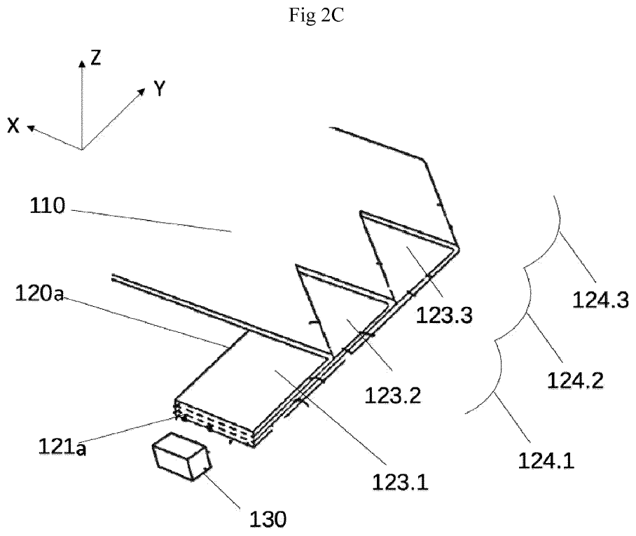

Thus, the light injection element 120 comprises an exit surface 122 extending in the longitudinal direction and able to inject light in a direction substantially normal to the exit surface 122. The light injection element 120 further comprises an entry surface 121, at one end of the light injection element 120, able to receive light rays from a light source 130, and the light injection element 120 is able to longitudinally guide the light along the Y-axis by distributing it over the exit surface 122. The light distribution via the exit surface 122 will be better understood in the light of the description of FIG. 2.

No restriction is imposed on the light source 130. The light source 130 may be able to generate light in a wavelength range. Such a range may be centered around a visible color, in order to generate colored light, for example, blue, red or green. As a variant, the light source 130 may emit light rays across the entire range of wavelengths visible to the human eye, so as to generate white light. A very narrow wavelength range can be produced by a laser type light source 130.

The light source 130 may be able to generate light in at least two distinct wavelength ranges, for example, corresponding to two distinct colors. It can be, for example, a light-emitting source of the LED type, for example, with the advantage of being small, having low energy consumption and limited heating, producing two different colors of light, able to be controlled by a control element which is not shown. It notably can be an RGB type diode, able to produce red, green and blue light. Thus, the luminous module according to the first embodiment can include a flexible guide sheet 110, an injection element 120 and a light source 130 able to generate light in at least two distinct wavelength ranges.

The light source 130 can be controlled by a control element which is not shown, but is described below, in order to vary the projected color and thus create a light animation.

As a variant, the light source 130 is not arranged directly facing the entry surface 121 of the injection element 120, but the luminous module 100 further comprises an optical fiber placed between the source 130 and the injection element 120, thereby moving the source 130 relative to the assembly formed by the injection element 120 and the flexible guide sheet 110.

FIG. 2A shows an injection element 120 of a luminous module according to embodiments of the invention.

The injection element 120 can comprise a plurality of injection guides 123 able to receive light from the source 130 via the entry surface 121 and to guide the light to a longitudinal position of the exit surface 122, with the longitudinal positions of the light guides being distinct so as to distribute the light to at least several longitudinal positions of the exit surface 122.

FIG. 2B shows the luminous module 100 with an injection element 120a that is integral with the flexible guide sheet 110. The injection element 120a comprises a set of light injection guides 123a that will be described with reference to the following figure, FIG. 2C.

With reference to FIG. 2C, the injection element 120a comprises a plurality of injection guides 123.1, 123.2 and 123.3 able to receive light from the source 130 via the entry surface 121a and to guide the light to the various positions along the distinct Y-axis 124.1, 124.2 and 124.3. As shown, the injection guides 123.1, 123.2 and 123.3 are made of the same material and they have the same thickness as the flexible film 111 of the guide sheet 110. Thus, the light guide 105 can be obtained by a roll-to-roll (or R2R) manufacturing procedure, during which the flexible film 111 and the injection sheets 123.1, 123.2 and 123.3 are obtained from the same roll of flexible film, with the injection sheets 123.1, 123.2 and 123.3 being cut at different Y-positions, in a cutting direction substantially parallel to the direction X. The injection sheets thus obtained are flexible and can be folded, as shown in FIG. 2C. The length of each injection sheet 123.1, 123.2 and 123.3 is selected so that once folded, their ends together form a stack with an injection surface 121a, as illustrated in FIG. 2C.

It is thus possible to inject light at various longitudinal positions along the Y-axis of the edge 114. Each longitudinal position of the edge 114 can correspond to a guide line of the flexible film 111, able to guide the light along the X-axis along such a guide line.

Such an association of a flexible guide sheet 110, an injection element 120 and a source 130 thus allows light to be projected in the Z direction via a flexible, transparent, semi-transparent or opaque surface, with good surface homogeneity and according to a given pattern.

In practice, such a luminous module can allow a pattern to be emitted with brightness ranging between 100 and 1,000 Candela per square meter, with a light extraction efficiency that can vary between 25% and 80%.

Details concerning the structure and the arrangement of these elements 110, 120 and 130 are described further in the international patent application published under number WO2011130715A2.

A luminous module for an external device for a vehicle according to the invention comprises:
an assembly of at least one guide sheet, such as the flexible guide sheet 110 illustrated in FIG. 1, with the assembly being able to reflect light according to at least one pattern;
at least one light injection element, such as the injection element 120 described with reference to FIGS. 1 and 2; and
at least one light source, such as the light source 130 described above with reference to FIG. 1, able to inject light into said at least one injection element.

“Pattern” is understood to mean any predefined spatial distribution of the luminous intensity emitted by the luminous module. In particular, reference is made herein to a two-dimensional or one-dimensional pattern. A pattern can thus include a two-dimensional shape or symbol obtained by contrasting between the luminous intensities of various positions in the X-Y plane of the flexible guide sheet 110. The pattern can also include several shapes or symbols. Alternatively, a pattern covers a predefined, or intentional, spatial distribution of luminous intensity that does not cause any general shape to appear, such as a distribution resulting in a cloud of luminous dots. Within the context of the present invention, a pattern is formed by injecting light into an injection element that is arranged relative to a flexible guide sheet so as to form the pattern on the flexible guide sheet. A flexible guide sheet is thus able to project light according to at least one pattern, and a pattern can correspond to at least one shape or symbol. A flexible guide sheet can also project light according to at least two patterns, when the flexible guide sheet is associated with several injection elements.

In the first embodiment, the luminous module comprises a single source, a single injection element and a single flexible guide sheet able to form a pattern.

In the second, third and fourth embodiments below, the luminous module comprises at least two injection elements similar to the injection element 120 described above. The embodiments can vary in terms of the number of elements included in the luminous module, and in terms of their respective arrangements. However, the descriptions and definitions provided above for the light source, the injection element and the flexible guide sheet apply to all the embodiments.

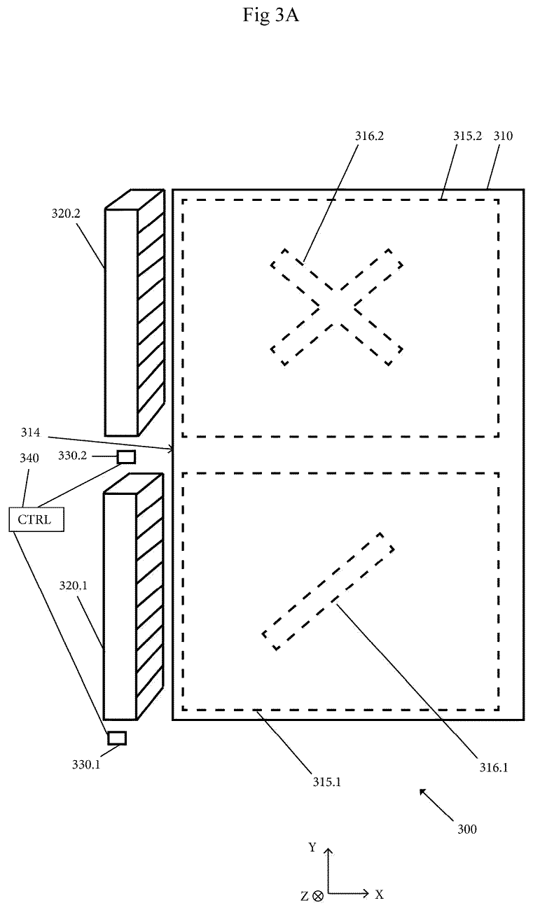

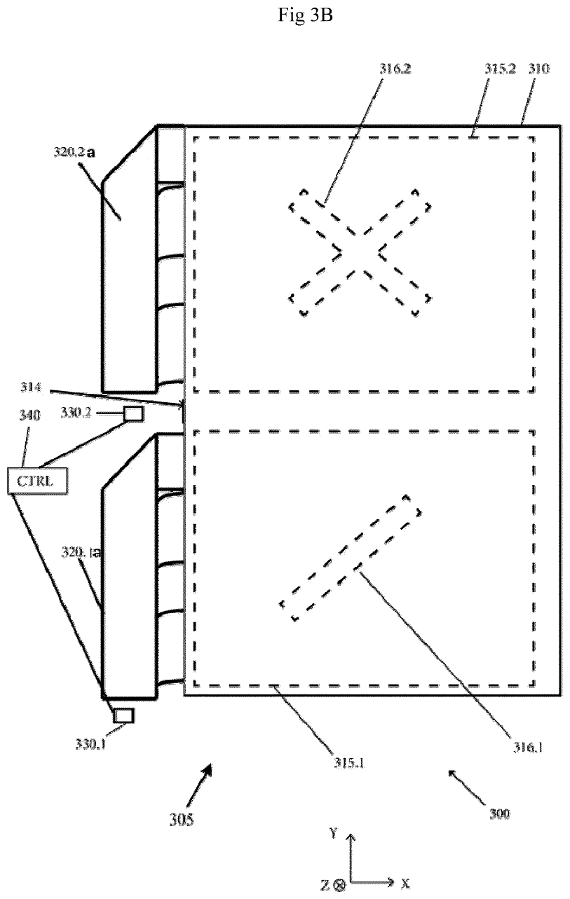

FIG. 3A illustrates a luminous module 300 according to a second embodiment of the invention.

In the second embodiment, several injection elements are arranged so as to inject light into the same flexible guide sheet, comprising several patterns.

In particular, in the example of FIG. 3A, a first injection element 320.1 and a second injection element 320.2 are arranged so as to inject light into an edge 314 of a flexible guide sheet 310.

The first and second injection elements 320.1 and 320.2 can be similar to the injection element 120 described with reference to FIGS. 1 and 2. Similarly, the flexible guide sheet 310 can correspond to the flexible guide sheet 110 described above.

As shown in FIG. 3A, the first injection element 320.1 and the second injection element 320.2 are arranged so as to inject light into the edge 314 at distinct longitudinal positions along the Y-axis.

It should be noted that, due to its flexibility, the guide sheet 310 may not be flat but may be curved. FIG. 3A thus shows the luminous module 300 when the guide sheet is flat, for example, placed on a flat rigid support.

The first injection element 320.1 is thus able to inject light into the edge 314, which is then guided by the flexible guide sheet 310 into a first portion 315.1 of the flexible guide sheet 310. The second injection element 320.2 is able to inject light into the edge 314, which is then guided into a second portion 315.2 of the flexible guide sheet 310.

To this end, a first source 330.1 is arranged facing an entry surface of the first injection element 320.1 so as to propagate light rays inside the first injection element 320.1 and therefore toward the first portion 315.1 of the flexible guide sheet 310. A second source 330.2 is arranged facing an entry surface of the second injection element 320.2 so as to propagate light rays inside the second injection element 320.2 and therefore toward the second portion 315.2 of the flexible guide sheet 310.

As a variant, a single source can be provided and the luminous module 300 comprises a first optical fiber able to convey light from the single source to the entry surface of the first injection element 320.1 and a second optical fiber is able to convey light from the single source to the entry surface of the second injection element 320.2.

The first and second sources 330.1 and 330.2, or the single source, can selectively inject into the first injection element 320.1 and/or into the second injection element 320.2. Such selective injection can be controlled by a control element 340 connected to the two sources 330.1 and 330.2, or controlling the power supply to the two sources 330.1 and 330.2.

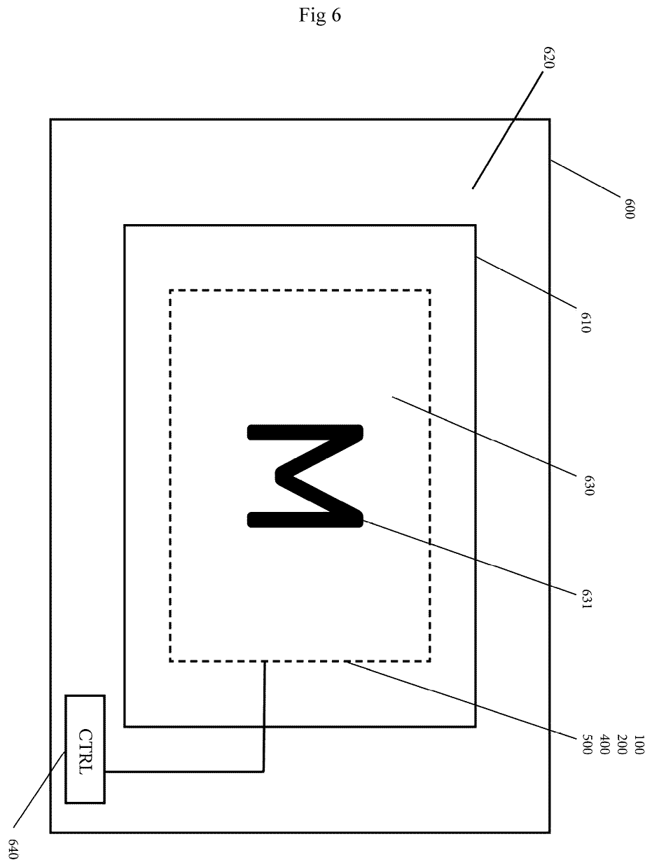

A first pattern 316.1 is etched into the first portion 315.1, while a second pattern 316.2 is etched into the second portion 315.2. The selective injection of light into the first injection element 320.1 and/or into the second injection element 320.2 thus allows projection of the first pattern, the second pattern, neither of the patterns or both patterns at the same time, thus allowing, by dynamic control, an animation to be produced from at least the first and second patterns, or allowing dynamic luminous information to be displayed. As a variant, the selective injection of light can be dynamically controlled as a function of touch input data received by the control element 340, as will be understood more clearly from the description of FIG. 6.

In the example of FIG. 3A, the first and second patterns 316.1 and 316.2 each correspond to a symbol, with the symbols being distinct. However, according to the definition of “pattern” provided above, the patterns can be any intentional, or predetermined, spatial distribution of luminous intensity. Furthermore, where the patterns are shapes or symbols, the first and second patterns 316.1 and 316.2 can have identical shapes. Animation is then enabled by the spatial movement of the pattern from the first portion 315.1 to the second portion 315.2, or vice versa. Furthermore, the colors respectively projected for each pattern can vary, when the sources 330.1 and 330.2 produce light of different colors.

An example with two patterns and two injection elements is shown in FIG. 3A. However, the first embodiment also covers a luminous module with a flexible guide sheet with three or more portions, with each portion comprising an etched pattern, and with at least three injection elements, with each injection element being placed facing one of the portions.

Dedicated sources for each injection element can be provided to this end, or a single source with several optical fibers can be provided to this end.

FIG. 3B illustrates a variant of the luminous module 300.

The variant is basically identical to the luminous module illustrated in FIG. 3A except for the differences described hereafter. In FIGS. 3A and 3B, elements that are identical use the same reference.

In the variant illustrated in FIG. 3A, the injection elements 320.1a and 320.2a are integrally formed with the flexible guide sheet 310. Indeed, the injection elements 320.1a and 320.2a are produced in the same manner as the injection element 120a shown in FIGS. 2B and 2C. Similarly, the flexible guide sheet 310 can correspond to the flexible guide sheet 110 described above. Thus, preferably, the injection elements 320.1a and 320.2a can form part of the flexible film of the sheet 110, and can be obtained by cutting and folding the flexible film, so as to form the light guide 305.

In the same manner as with the luminous module illustrated in FIG. 3A, the light injection elements 320.1a and 320.2a are arranged facing the same edge 314 of the flexible guide sheet 310. However, the first light injection element 320.1a is disposed facing a first section of the edge 314, while the second light injection element 320.2a is disposed facing a second section of the edge 314. In this way, these light injection elements 320.1a and 320.2a illuminate two different portions of the guide sheet 310. In the illustrated example, they respectively illuminate the first portion 315.1 and the second portion 315.2.

FIG. 3B also illustrates a first pattern comprising a first symbol 316.1 that is etched into the first portion 315.1, while a second pattern comprising a second symbol 316.2 is etched into the second portion 315.2. However, the first portion and the second portion alternatively may be able to emit light in homogeneous patterns, with a constant brightness over the whole of the first portion 315.1 and the second portion 315.2. The projection of symbols 316.1 and 316.2 is thus optional.

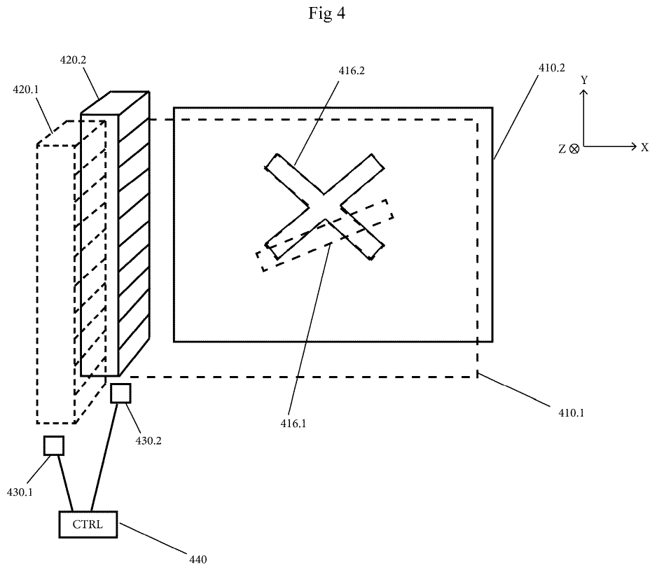

FIG. 4 illustrates a luminous module 400 according to a second embodiment of the invention.

In the second embodiment of the invention, the luminous module 400 comprises at least one first flexible guide sheet 410.1 and one second flexible guide sheet 410.2, with the two flexible guide sheets being overlaid, which implies that at least one portion of the first flexible guide sheet 410.1, in the X-Y plane, is overlaid with at least one portion of the second flexible guide sheet 410.2, in a common area, which corresponds to a set of positions in the X-Y plane.

Preferably, the first and second flexible guide sheets 410.1 and 410.2 have the same dimensions in the X-Y plane, and are fully overlaid.

It should be noted that, due to their flexibility, the guide sheets may not be flat but may be curved. FIG. 4 thus shows the luminous module 400 when the guide sheets are flat, for example, stacked on a flat support.

Such overlaying is notably advantageous because the flexible guide sheets are preferably transparent, as described above.

Thus, the first and second flexible guide sheets 410.1 and 410.2 are able to project a first pattern 416.1 and a second pattern 416.2, respectively, into a common area.

A first injection element 420.1 is able and arranged to inject light into an edge of the first flexible guide sheet 410.1 and a second injection element 420.2 is able and arranged to inject light into an edge of the second guide sheet 410.2.

To this end, a first source 430.1 is arranged facing an entry surface of the first injection element 420.1 so as to propagate light rays inside the first injection element 420.1 and therefore toward the first flexible guide sheet 410.1. A second source 430.2 is arranged facing an entry surface of the second injection element 420.2 so as to propagate light rays inside the second injection element 420.2 and therefore toward the second flexible guide sheet 410.2.

As a variant, a single source can be provided and the luminous module comprises a first optical fiber able to convey light from the single source to the entry surface of the first injection element 420.1 and a second optical fiber is able to convey light from the single source to the entry surface of the second injection element 420.2.

The first and second sources 430.1 and 430.2, or the single source, can selectively inject into the first injection element 420.1 and/or into the second injection element 420.2. Such selective injection can be controlled by a control element 440 connected to the two sources 430.1 and 430.2, or controlling the power supply to the two sources 430.1 and 430.2.

The first pattern 416.1 is etched into the first flexible guide sheet 410.1, while the second pattern 416.2 is etched into the second flexible guide sheet 410.2. The selective injection of light into the first injection element 420.1 and/or into the second injection element 420.2 thus allows projection of the first pattern, the second pattern, none of the patterns or both patterns at the same time, thus allowing, by dynamic control, an animation to be produced from at least the first and second patterns.

In the example of FIG. 4, the first and second patterns 416.1 and 416.2 have distinct symbols, and are identical to the patterns 316.1 and 316.2 of FIG. 3, for illustrative purposes. However, according to the definition of a pattern provided above, the patterns can be any intentional, or predetermined, spatial distribution of luminous intensity. Furthermore, where the patterns are shapes or symbols, the first and second patterns 416.1 and 416.2 can have identical symbols but distinct colors. Indeed, the colors respectively projected for each pattern can vary, when the sources 430.1 and 430.2 produce light of different colors.

An example with two patterns, two injection elements and two flexible guide sheets was shown in FIG. 4. However, the second embodiment also covers a luminous module with at least three flexible guide sheets with at least three injection elements, with each injection element being placed facing one of the flexible guide sheets. Sources dedicated to each injection element can be provided to this end, or a single source with several optical fibers can be provided to this end.

At least one of the flexible guide sheets can be transparent. As a variant, according to the second embodiment, the flexible guide sheet located below the luminous module 400, i.e., the first flexible guide sheet 410.1, can be opaque or semi-transparent. Conversely, the second flexible guide sheet 410.2 is transparent or semi-transparent, so as to allow through at least some of the light emitted by the first flexible guide sheet 410.2. The second flexible guide sheet 410.2 can further comprise a textured material, so as to improve the esthetic appearance of the luminous module and/or so as to harmonize its material with the material of the external device in which the luminous module is integrated. Such a textured material also can be used for the flexible guide sheets of the luminous modules according to the first, second and fourth embodiments. Textured material is understood to mean any material having a predefined texture involving, for example, a surface treatment of the flexible guide sheet. The textured material can include grains, ridges or cracks or any other textural element.

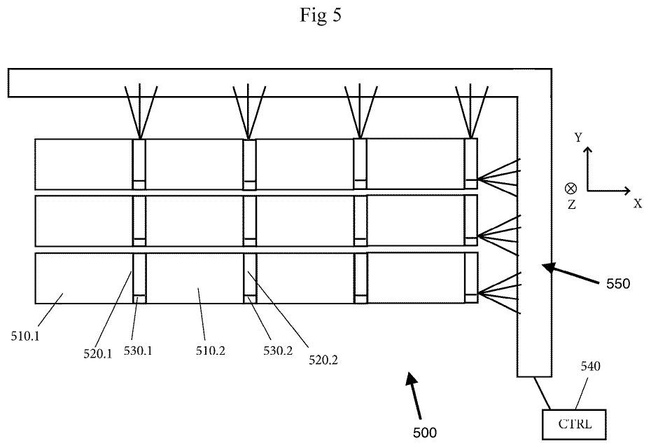

FIG. 5 illustrates a luminous module 500 according to a fourth embodiment of the invention.

In the fourth embodiment of the invention, the luminous module 500 comprises at least one first flexible guide sheet 510.1 and one second flexible guide sheet 510.2, with the two flexible guide sheets being placed next to one another, and the two flexible guide sheets are thus able to project light rays from distinct positions in the X-Y plane in which the flexible guide sheets mainly extend.

It should be noted that, due to their flexibility, the guide sheets may not be flat but may be curved. FIG. 5 thus shows the luminous module 500 when the flexible guide sheets are flat, for example, placed on a flat rigid support.

Thus, the first flexible guide sheet 510.1 is able to project a first pattern, not shown, at a first position on the X-Y plane, and the second flexible guide sheet 510.2 is able to project a second pattern 516.2 at a second position on the X-Y plane, with the first and second positions being distinct, for example, next to one other. Each projected pattern can include a symbol or portion of a symbol. When a pattern of a flexible guide sheet includes a portion of a symbol, this portion can match another portion of a symbol formed by the pattern of another flexible guide sheet, or other portions of symbols formed by the patterns of other flexible guide sheets.

A first injection element 520.1 is arranged to inject light into an edge of the first flexible guide sheet 510.1 and a second injection element 520.2 is arranged to inject light into an edge of the second guide sheet 510.2.

The relative arrangement of each injection element relative to a flexible guide sheet is in accordance with the explanations set forth above, and is not described in detail again for the fourth embodiment of FIG. 5.

A first source 530.1 is arranged facing an entry surface of the first injection element 520.1 so as to propagate light rays inside the first injection element 520.1 and therefore toward the first flexible guide sheet 510.1. A second source 530.2 is arranged facing an entry surface of the second injection element 520.2 so as to propagate light rays inside the second injection element 520.2 and therefore toward the second flexible guide sheet 510.2.

As a variant, a single source can be provided and the luminous module 500 comprises a first optical fiber able to convey light from the single source to the entry surface of the first injection element 520.1 and a second optical fiber is able to convey light from the single source to the entry surface of the second injection element 520.2.

The first and second sources 530.1 and 530.2, or the single source, can selectively inject light into the first injection element 520.1 and/or into the second injection element 520.2. Such selective injection can be controlled by a control element 540 connected to the two sources 530.1 and 530.2, or controlling the power supply to the two sources 530.1 and 530.2.

The first pattern is etched into the first flexible guide sheet 510.1, while the second pattern is etched into the second flexible guide sheet 510.2. The selective injection of light into the first injection element 520.1 and/or into the second injection element 520.2 thus allows projection of the first pattern, the second pattern, none of the patterns or both patterns at the same time, thus allowing, by dynamic control, an animation to be produced from at least the first and second patterns.

In the example of FIG. 5, a luminous module 500 comprising twelve flexible guide sheets, twelve injection elements and twelve light sources, arranged in a matrix with three rows and four columns, has been shown, purely for illustrative purposes.

No restriction is imposed on the number of flexible guide sheets in the third embodiment. The third embodiment thus applies to N flexible guide sheets, N respectively associated injection elements, and N luminous sources, or a single source connected by N optical fibers to the N injection elements, with N being any integer greater than or equal to 2.

In addition, no restriction is imposed on the arrangement of the flexible guide sheets relative to each other. When positioned as matrices, no restriction is imposed on the number of rows or the number of columns.

The first and second patterns can assume distinct shapes, and can be identical, for example, to the patterns 316.1 and 316.2 of FIG. 3. However, according to the definition of “pattern” provided above, the patterns can be any intentional, or predetermined, spatial distribution of luminous intensity. Furthermore, where the patterns are shapes or symbols, the first and second patterns can have identical symbols but distinct colors. Indeed, the colors respectively projected for each pattern can vary, when the sources 530.1 and 530.2 produce light of different colors.

Furthermore, as explained above, the patterns can include portions of symbols that match one another, so as to form one or more symbols over several flexible guide sheets of the matrix.

The flexible guide sheets can be connected to one another by a supporting matrix structure, which itself can be flexible. As a variant, each flexible guide sheet can be connected to the surrounding flexible guide sheets by fastening means, by adhesive bonding, clamping, clipping, or any other method.

The set of light sources can be controlled by the control element 540, via a set of wires, with each wire connecting the control element 540 to a light source. The wires can be supported by a structure 550 for centralizing the wires and conveying them to the control element, thus reducing bulk, and also allowing the wires to be shielded.

No restriction is imposed on the dimensions in the X-Y plane of the flexible guide sheets. For example, each flexible guide sheet can be rectangular or square, with at least one dimension ranging between 2 and 10 cm. For example, the flexible guide sheets are squares or rectangles, with:
a dimension ranging between 2 cm and 10 cm, for example, between 2 cm and 5 cm, for example, equal to 5 cm; and
another dimension ranging between 2 cm and 10 cm, for example, between 2 cm and 5 cm, for example, equal to 5 cm.

For example, each flexible guide sheet is a 3 cm by 3 cm square.

The second, third and fourth embodiments have been described exclusively in relation to one another. However, it should be noted that these three embodiments can be combined in the same luminous module, in particular:
the second embodiment and the third embodiment can be combined: at least two flexible guide sheets are overlaid, and one of the two flexible guide sheets is associated with two light injection guides able to selectively inject light into two distinct portions of the guide sheet, with two patterns being respectively etched into the two portions;
the second embodiment and the fourth embodiment can be combined: at least two flexible guide sheets are placed next to one another, and one of the two flexible guide sheets is associated with two light injection guides able to selectively inject light into two distinct portions of the guide sheet, with two patterns being respectively etched into the two portions;
the third embodiment and the fourth embodiment can be combined: at least two flexible guide sheets are placed next to each other, and one of the two flexible guide sheets is overlaid with a third flexible guide sheet of the luminous module;
the second embodiment, the third embodiment and the fourth embodiment can be combined: at least two flexible guide sheets are placed next to each other, and one of the two flexible guide sheets is overlaid with a third flexible guide sheet of the luminous module, and one of these three flexible guide sheets is associated with two light injection guides able to selectively inject light into two distinct portions of the guide sheet, with two patterns being respectively etched into the two portions.

FIG. 6 illustrates an external rear device 600 for an automotive vehicle according to some embodiments of the invention.

The external rear device 600 according to the invention comprises a luminous module 100, 300, 400, 500 according to any of the embodiments described above, or according to a combination of several of the embodiments described above, as well as an external rear surface 620, on which the luminous module 100, 300, 400, 500 is attached.

An external rear surface is understood to mean a surface that can be accessed by a user when the external rear device is mounted at the rear of the vehicle. It therefore differs from an internal surface, which can only be accessed by removing said device, or when the device is not mounted in the vehicle.

“External rear device” is understood to mean any device comprising at least one external surface intended to be accessible to a user from the outside at the rear of the automotive vehicle. It thus can be a bodywork element at the rear of the vehicle or a rear luminous device such as the signaling devices at the rear of the vehicle.

No restriction is imposed on the way in which the luminous module 100, 300, 400, 500 is attached to the external surface 620.

The luminous module 100, 300, 400, 500 can be inserted, for example, into a frame or a support of the external rear device 600 that is provided to this end, notably assuming a shape that matches the luminous module 100, 300, 400, 500, and is retained in position by adhesive bonding, screwing, clipping, clamping, or any other type of retention means or fixing means. As a variant, the luminous module 100, 300, 400, 500 is directly adhered to the external surface 620 of the external rear device 600.

The external rear device 600 can also include a control element 640, which can be one of the control elements previously described with reference to the four embodiments. Thus, the control element 640 can be outside the luminous module 100, 300, 400, 500. As a variant, it can be inside the luminous module 100, 300, 400, 500, as described above.

The control element 640 can comprise a processor configured to communicate unidirectionally or bidirectionally, via one or more buses or via a wired connection, with a memory, such as a random access memory (RAM) or a read only memory (ROM) or any other type of memory (flash, EEPROM, etc.). As a variant, the memory comprises several memories of the aforementioned types. Preferably, the memory is a non-volatile memory. The processor is able to execute instructions stored in the memory to implement one or more animations based on the reception of animation commands. Alternatively, the processor can be replaced by a microcontroller designed and configured to implement one or more animations based on the reception of animation commands.

Preferably, the external rear device 600 can further comprise a protective layer 610.

No restriction is attached to such a protective layer 610, which at least provides mechanical protection by covering the luminous module 100, 300, 400, 500. Preferably, the mechanical protective layer covers the entire luminous module 100, 300, 400, 500, which increases its mechanical protection and therefore its service life. The external devices 600 for an automotive vehicle are notably exposed to mechanical impacts, as well as to bad weather such as rain or hail in particular.

The luminous module 100, 300, 400, 500 is thus included between the external surface 620 and the protective layer 610.

Furthermore, the protective layer 610 can include an anti-UV treatment or can include an ultraviolet ray filtering material. The protective layer 610 thus simultaneously provides mechanical protection but also prevents damage to the one or more patterns in the luminous module 100, 300, 400, 500.

The luminous module 100, 300, 400, 500 is able to form one or more patterns 630 comprising a symbol 631, as shown in FIG. 6. Such a pattern example is provided by way of an illustration only, as explained above.

Depending on the considered embodiment, the pattern 630 can be projected by one or more flexible guide sheets:
in the first embodiment, the pattern 630 is formed by a single flexible guide sheet of a luminous module 100;
in the second embodiment, the pattern 630 is formed by a single flexible guide sheet of a luminous module 300, but the symbol 631 can be divided into two portions and each portion of the symbol 631 can be projected by selective injection into two injection elements facing distinct sections of the edge of the flexible guide sheet, so as to project the two portions of the symbol 631 into two distinct zones. As a variant, the pattern 630 comprises two distinct patterns, with each pattern being able to be projected into a portion of the flexible guide sheet by selective injection into one of the injection elements. The projected pattern can thus include one symbol, the other symbol, both symbols or no symbol. More generally, the selective injection into one, the other or both injection elements allows the projected pattern 630 to be dynamically varied;
in the third embodiment, the pattern 630 is formed by overlaying at least two flexible guide sheets of a luminous module 400. According to a first example, each flexible guide sheet produces the same pattern 630, but in different colors, which allows the colors to be dynamically varied. Thus, a first flexible guide sheet is able to project the symbol 631 according to a first color, and the second flexible guide sheet is able to project the symbol 631 according to a second color, identical to or different from the first color, and the injection of light is selectively controlled between the two flexible guide sheets, so as to dynamically vary the projected pattern 630, as in the second embodiment;
in the fourth embodiment, the pattern 630 is formed by a matrix of at least two flexible guide sheets next to one another. Thus, in a first example, a first flexible guide sheet projects a portion of the symbol 631 and a second flexible guide sheet projects another portion of the symbol 631. As a variant, the luminous module 500 comprises more than two flexible guide sheets, and each flexible guide sheet is able to project a portion of the symbol 631. For example, each symbol can be produced by four flexible guide sheets.

When multiple symbols are formed by the pattern 630, each symbol can be projected into a given area of the luminous module 100, 300, 400, 500. A first symbol can be projected into a first given area of the luminous module, and a second symbol can be projected into a second given area of the luminous module.

The control element 640 is able to control the one or more sources of the luminous module 100, 300, 400, 500. For example:
the control element 640 can vary the luminous intensity of the pattern;
the control element 640 can vary the color of the pattern 630;
the control element can activate or deactivate some of the light sources.

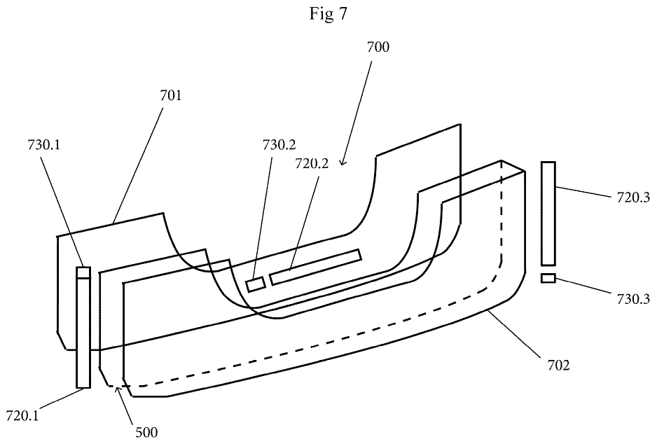

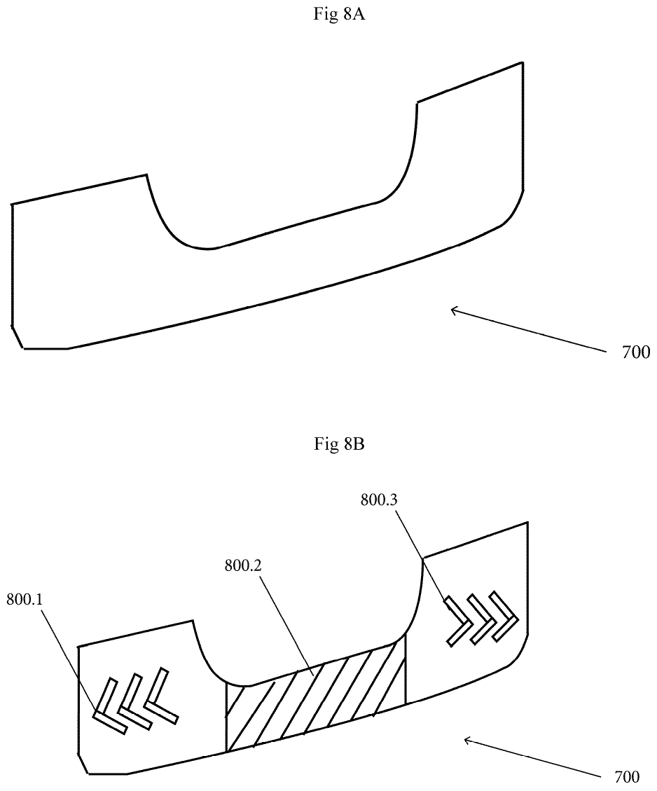

FIGS. 7, 8a and 8b illustrate a first embodiment of an external rear device 700 according to the invention.

The external rear device 700 can include the overlaying:
of a panel 701 that can be arranged at the rear of a vehicle. It can be, for example, a panel with a different appearance or color from the rest of the bodywork of the vehicle, and assuming a shape defining a signature of the vehicle. For example, the panel 701 can be a black panel:
of one or more luminous modules 100, 200, 400, 500 according to one of the previously described embodiments. In the example of FIG. 7, which is provided solely by way of an illustration, a luminous module 500 is shown comprising three flexible guide sheets arranged in a matrix according to the embodiment of FIG. 5. The flexible guide sheets of the luminous module 500 are respectively associated with a first light source 730.1 and a first light injection element 720.1, a second source 730.2 and a second light injection element 720.2, and a third source 730.3 and a third light injection element 720.3;
optionally an encapsulation layer 702, which can be similar to the previously described protective layer 610. In addition to protecting the luminous module 500 mechanically and/or against UV, the encapsulation layer can fulfil the function of encapsulating the luminous module 500 between the encapsulation layer 702 and the panel 701. The encapsulation layer 702 is at least partially transparent or even fully transparent.

In the example of FIG. 7, the panel 701, the luminous module 500 and the encapsulation layer 702 have identical shapes and are fully overlaid. However, according to the invention, the luminous module 500 can only partially cover the panel 701.

In the aforementioned overlay, the panel 701 is located toward the inside of the vehicle, while the encapsulation layer 702 is located toward the outside of the vehicle.

FIG. 8A shows a view of the external rear device 700 shown with reference to FIG. 7, when the one or more light sources of the luminous module of the device 700 are turned off. The external rear device 700 then has the appearance of the panel 701, optionally modulated by the encapsulation layer 702 when it is not fully transparent. For example, the external rear device 700 can be black.

FIG. 8B shows a view of the external rear device 700 shown with reference to FIG. 7, when at least one of the light sources of the luminous module of the device 700 is turned on. In FIG. 8B, the three light sources 720.1, 720.2 and 720.3 are turned on, by way of an illustration. The patterns etched into each of the flexible guide sheets of the luminous module 500 can be different, as shown in FIG. 8B. The central guide sheet, which is associated with the second light source 730.2, can have, for example, a homogeneous pattern, i.e., the flexible guide sheet reflects the light from the light source 730.2 over its entire surface. The central portion of the device 700 then assumes the color of the light injected by the second light source 730.2, which can be white or red, for example. A homogeneous pattern 800.2 is thus displayed in the central portion of the external rear device 700. A red light advantageously can be displayed when the vehicle brakes, in order to show following vehicles that the vehicle is decelerating.

The lateral guide sheets can be etched with distinct patterns 800.1 and 800.3, for example, symmetrical patterns, as shown in FIG. 8B. The patterns 800.1 to 800.3 can match and thus assist in indicating the same signaling information, or can indicate different signaling information.

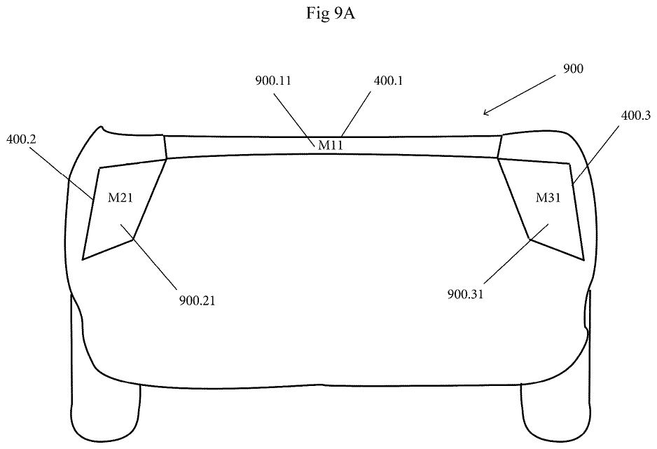

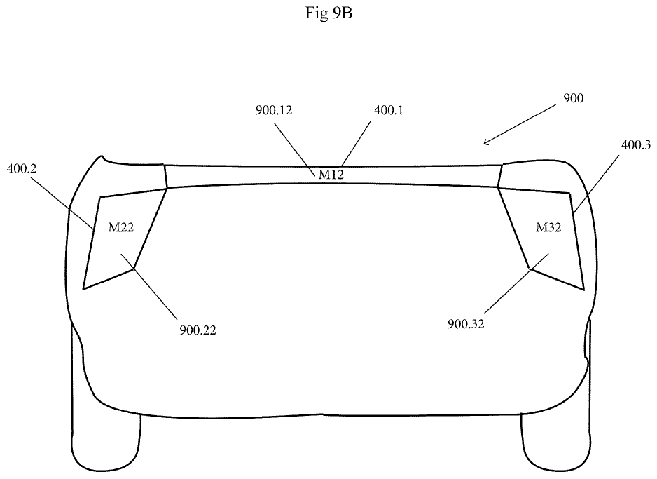

FIGS. 9a and 9b illustrate a second embodiment of an external rear device 900.

The device 900 can comprise one or more luminous modules 400 according to the embodiment of FIG. 4, wherein at least two flexible guide sheets are overlaid.

In the example of FIGS. 9a and 9b, the external rear device 900 comprises three luminous modules of this type, namely, a first luminous module 400.1 in a central position, connecting the two rear lights of the automotive vehicle, a second luminous module 400.2 positioned on the left rear light and a third luminous module 400.3 positioned on the right rear light.

Each of the luminous modules 400.1 to 400.3 thus comprises several overlaid flexible guide sheets. Throughout the remainder of the description, each luminous module 400.1 to 400.3 is considered to include two overlaid flexible guide sheets, namely, a first and a second flexible guide sheet.

The first flexible guide sheet of each luminous module is associated with a first light source and a first light injection element and the second flexible guide sheet of each luminous module is associated with a second light source and a second light injection element.

In FIG. 9A, the first light source of each luminous module is activated and the second light source is turned off:
the first flexible guide sheet of the luminous module 400.1 is etched according to a first pattern 900.11 and the first pattern 900.11 can be seen by activating the first light source of the luminous module 400.1;
the first flexible guide sheet of the luminous module 400.2 is etched according to a second pattern 900.21 and the second pattern 900.21 can be seen by activating the first light source of the luminous module 400.2;
the first flexible guide sheet of the luminous module 400.3 is etched according to a third pattern 900.31 and the third pattern 900.31 can be seen by activating the first light source of the luminous module 400.2.

The first, second and third patterns can be the same or can differ. For example, the two lateral patterns, namely, the second pattern 900.21 and the third pattern 900.31, can be identical to each other, but can differ from the first pattern 900.11 in the central position. Each pattern can correspond to signaling information that is provided for the attention of vehicles following the automotive vehicle comprising the external rear device 900.

In FIG. 9B, the second light source of each luminous module is activated and the first light source is turned off:
the second flexible guide sheet of the luminous module 400.1 is etched according to a fourth pattern 900.12 and the fourth pattern 900.12 can be seen by activating the second light source of the luminous module 400.1;
the second flexible guide sheet of the luminous module 400.2 is etched according to a fifth pattern 900.22 and the second pattern 900.22 can be seen by activating the second light source of the luminous module 400.2;
the second flexible guide sheet of the luminous module 400.3 is etched according to a sixth pattern 900.32 and the sixth pattern 900.32 can be seen by activating the second light source of the luminous module 400.2.

The fourth, fifth and sixth patterns can be the same or can differ. For example, the two lateral patterns, namely, the fifth pattern 900.22 and the sixth pattern 900.32, can be identical to each other, but can differ from the fourth pattern 900.12 in the central position. Each pattern can correspond to signaling information that is provided for the attention of vehicles following the automotive vehicle comprising the external rear device 900.

The first pattern 900.11 is different from the fourth pattern 900.12. Thus, the signaling information emitted by the luminous module 400.1 can vary and can be controlled by a control unit that selectively powers the first source or the second source of the luminous module 400.1. The same applies to the other luminous modules:
the second pattern 900.21 is different from the fifth pattern 900.22. Thus, the signaling information emitted by the luminous module 400.2 can vary and can be controlled by a control unit that selectively powers the first source or the second source of the luminous module 400.2; and
the third pattern 900.31 is different from the sixth pattern 900.32. Thus, the signaling information emitted by the luminous module 400.3 can vary and can be controlled by a control unit that selectively powers the first source or the second source of the luminous module 400.3.

The present invention is not limited to the embodiments that have been described above by way of examples; it extends to other variants.

What is claimed is:

1. An external rear device for an automotive vehicle, the device comprising a surface, on which at least one luminous module is arranged, with each luminous module including:
an assembly of at least one flexible guide sheet, with each flexible guide sheet of the assembly being able to receive light rays via at least one edge of the flexible guide sheet and to reflect the light rays in a direction substantially normal to a surface of the flexible guide sheet in at least one pattern etched into the flexible guide sheet;
at least one light injection element able to receive light and to distribute the light in the assembly of at least one flexible guide sheet; and
at least one light source able to inject light into the at least one light injection element.

2. The external rear device as claimed in claim 1, further comprising a protective layer arranged on the at least one luminous module, with the luminous module being included between the surface and the protective layer.

3. The external rear device as claimed in claim 2, wherein the protective layer is transparent and is able to filter ultraviolet rays.

4. The external rear device as claimed in claim 2, wherein the protective layer is an encapsulation layer able to encapsulate the luminous module between the surface and the encapsulation layer.

5. The external rear device as claimed in claim 1, wherein the surface is a rigid panel with a given appearance, with the device having the appearance when each light source is disabled, and wherein the pattern of the at least one flexible guide sheet changes the appearance of the surface when at least one light source is activated.

6. The external rear device as claimed in claim 1, wherein the device includes a tail light for an automotive vehicle, and wherein at least one flexible guide sheet at least partially covers the tail light for an automotive vehicle.

7. The external rear device as claimed in claim 6, wherein the device includes a right tail light and left tail light for an automotive vehicle, including a first luminous module arranged in a central position between the right tail light and the left tail light, a second luminous module arranged on the left tail light, and a third luminous module arranged on the right tail light.

8. The external rear device as claimed in claim 7, wherein the at least one pattern of the second luminous module is identical to the at least one pattern of the third luminous module, and wherein the at least one pattern of the first luminous module is different from the at least one pattern of the second luminous module and of the third luminous module.

9. (canceled)

10. The external rear device as claimed in claim 1, wherein at least one luminous module is able to display at least one symbol in a given area of the luminous module based on the pattern of the at least one flexible guide sheet of the assembly.

11. The external rear device as claimed in claim 1, wherein at least one luminous module is able to display at least one first symbol in a given first area of the luminous module and at least one second symbol in a given second area of the luminous module based on the pattern of the at least one flexible guide sheet of the assembly.

12. The external rear device as claimed in claim 1, wherein, for at least one luminous module, the luminous module includes a first injection element and a second injection element, the at least one source is able to selectively inject light into the first injection element and into the second injection element, and the first light injection element and the assembly of at least one flexible guide sheet are arranged so as to project light according to a first pattern and wherein the second light injection element and the assembly of at least one flexible guide sheet are arranged so as to project light according to a second pattern.

13. The external rear device as claimed in claim 12, wherein the luminous module includes a first light source able to inject light into the first light injection element and a second light source able to inject light into the second light injection element.

14. The external rear device as claimed in claim 12, wherein the first injection element is arranged so as to inject light into a first section of the edge of the guide sheet of the assembly, and wherein the second injection element is arranged so as to inject light into a second section of the edge of the flexible guide sheet, with a first portion of the flexible guide sheet located facing the first section of the edge being etched according to the first pattern, and a second portion of the flexible guide sheet located facing the second section of the edge being etched according to the second pattern.

15. The external rear device as claimed claim 12, wherein the assembly includes at least one first and one second flexible guide sheet, with the first pattern being etched into the first flexible guide sheet and the second pattern being etched into the second flexible guide sheet, the first injection element being arranged so as to inject light into an edge of the first flexible guide sheet and the second injection element being arranged so as to inject light into an edge of the second flexible guide sheet.

16. The external rear device as claimed in claim 15, wherein the first and second guide sheets are overlaid in the luminous module in order to project the first and second patterns into a common area of the luminous module.

17. The external rear device as claimed in claim 15, wherein the first and second flexible guide sheets are placed next to each other so as to project the first and second patterns at distinct positions.

18. The external rear device as claimed in claim 1, wherein the assembly includes more than two flexible guide sheets placed next to each other so as to form a matrix of flexible guide sheets, with each flexible guide sheet being associated with a light injection element able to inject light into an edge of the flexible guide sheet and each flexible guide sheet having at least one pattern etched into the sheet.

19. The external rear device as claimed in claim 1, further comprising a control element is, with the control element being able to control the at least one source to selectively project light according to a first pattern and according to a second pattern.

20. (canceled)

21. The external rear device as claimed in claim 1, wherein each flexible guide sheet includes a film including microstructures, wherein each pattern is etched by ultra-violet printing the microstructures of the film and a surface density of microstructures decreases with the distance from the edge of the guide sheet into which the light is injected.

22. (canceled)

23. The external rear device as claimed in claim 21, wherein each injection element includes a plurality of injection guides, with each injection guide being able to receive light from one end of the guide and to guide the light to a given longitudinal position of the injection element, with the longitudinal positions of the injection guides all being different so as to longitudinally distribute the light in the injection element.
